(19) United States
(12) Patent Application Publication
(10) Pub. No.: US 2024/0035941 A1
(43) Pub. Date: Feb. 1, 2024

(54) METHOD AND DEVICE FOR DETERMINING, IN PARTICULAR, MICROMECHANICAL PROPERTIES OF A MATERIAL, IN PARTICULAR, FOR DESCRIBING GRAIN SIZE DEPENDENCIES

(71) Applicant: Robert Bosch GmbH, Stuttgart (DE)

(72) Inventors: Erik Natkowski, Korntal-Muenchingen (DE); Petra Sonnweber-Ribic, Leonberg (DE); Jannick Kuhn, Karlsruhe (DE)

(21) Appl. No.: 18/360,726

(22) Filed: Jul. 27, 2023

(30) Foreign Application Priority Data
Jul. 29, 2022 (DE) 10 2022 207 846.2

(51) Int. Cl. G01N 3/06

(52) U.S. Cl. CPC G01N 3/066; G01N 2203/0073; G01N 2203/0218

(57) ABSTRACT

A device and computer-implemented method for determining an, in particular, micromechanical property of a material, in particular, for describing grain size dependencies, wherein a grain size-independent parameter is predefined (202), a grain size-dependent parameter being determined (204, 206) as a function of the grain size-independent parameter, and the property of the material being determined (208) as a function of the grain size-independent parameter and of the grain size-dependent parameter.

### FIELD

The present invention relates to a method and to a device for determining a micromechanical property of a material for describing grain size dependencies.

### BACKGROUND INFORMATION

Local crystal plasticity models for fatigue simulations describe a mechanical behavior usually as a function of a local yield stress and of kinematic hardening parameters. An ascertainment of these parameters takes place, for example, by solving an inverse optimization problem. In this case, the relevant parameters of the crystal plasticity model for fatigue simulations are determined based on the cyclically stabilized stress-strain behavior to be described in such a way that this behavior is preferably well mapped.

J. Kuhn, J. Spitz, P. Sonnweber-Ribic, M. Schneider, T. Böhlke, “Identifying material parameters in crystal plasticity by Bayesian optimization,” August 2021, Optimization and Engineering, doi:10.1007/s11081-021-09663-7 and J. Segurado, J. Llorca, “Simulation of the deformation of polycrystalline nanostructured Ti by computational homogenization,” Computational Materials Science 76 (2013) 3-11: doi:10.1016/j.commatsci.2013.03.008 describe aspects of an inverse parameter identification for solving the inverse optimization problem.

The grain size dependency may be reproduced in a crystal plasticity model, for example, using a Hall-Petch approach. This approach is considered below as an example.

Expanded local crystal plasticity models with Hall-Petch effect describe the material behavior as a function of the grain size, for which additional parameters are introduced. In practical application, however, there are usually no grain size-dependent measured data available describing the material behavior for various grain sizes.

Moreover, the inverse optimization of the parameters by two factors becomes significantly more complex.

On the one hand, a real illustration of the microstructure including the present grain size distribution is now necessary, whereas simplified illustrations are otherwise sufficient. In addition, a number of the parameters to be ascertained increases, as a result of which the parameter space on the whole is expanded. Taken together, these factors increase the computing effort and expenditure of time considerably.

### SUMMARY

A local crystal plasticity model with Hall-Petch effect, in particular, is parameterized in a simple manner by the method and the device according to the present invention. For this purpose, according to an example embodiment of the present invention, a parameterization within the scope of an inverse optimization may initially take place without taking the grain size effect into account. Thereafter, a grain size-independent proportion of a yield stress may be ascertained by an integration of a measured grain size distribution as well as of parameter values described, for example, in the literature. Finally, grain size-dependent parameter values may be ascertained. A parameterization of a local crystal plasticity model expanded by grain size effects may subsequently take place using the measured grain size distribution and an associated cyclical behavior while including known parameter values, in particular, taking the Hall-Petch effect into account.

According to an example embodiment of the present invention, a computer-implemented method for determining an, in particular, micromechanical property of a material, in particular, for describing grain size dependencies, provides that a grain size-independent parameter is predefined, a grain size-dependent parameter being determined as a function of the grain size-independent parameter, and the property of the material being determined as a function of the grain size-independent parameter and of the grain size-dependent parameter.

According to an example embodiment of the present invention, the grain size-independent parameter is predefined preferably regardless of location, one location-dependent grain size-dependent parameter of a plurality of location-dependent grain size-dependent parameters being determined as a function of the grain size-independent parameter, at least one other location-dependent grain size-dependent parameter of the plurality of location-dependent grain size-dependent parameters being determined as a function of the location-dependent grain size-dependent parameter. This means that not each of the plurality of location-dependent grain size-dependent parameters is determined directly as a function of a location-dependent grain size-dependent parameter. It is sufficient to determine one of the plurality of location-dependent grain size-dependent parameters as a function of the grain size-independent parameter.

According to an example embodiment of the present invention, the grain size-independent parameter is preferably assigned to a part of a volume of the material, a plurality of values of one of the location-dependent grain size-dependent parameters being assigned to different locations in the part of the volume of the material, and a value of the location-dependent grain size-dependent parameter being determined, for which a mean value of the plurality of values is essentially the same as the grain size-independent parameter. This improves a result of the determination of the property of the material.

According to an example embodiment of the present invention, it is preferably provided that the volume is subdivided into a number of grains, which are assigned to one location each, for a grain that is assigned to that location, an equivalent diameter of the grain being predefined as a function of a predefined distribution of equivalent diameters for grains of the material in the volume, and the value of the location-dependent grain size-dependent parameter being determined as a function of the equivalent diameter of this grain. This improves a result of the determination of the property of the material.

According to an example embodiment of the present invention, the distribution of equivalent diameters is determined preferably as a function of microstructure data which characterize a grain size. These microstructure data improve a result of the determination of the property of the material.

According to an example embodiment of the present invention, a grain size-independent parameter characterizes preferably a critical shear stress of the material, the location-dependent grain size-dependent parameter being determined as a function of the grain size-independent parameters and of a function in dependency on the equivalent diameters for the grains of the material in the volume. This parameter is particularly well suited for determining the location-dependent grain size-dependent parameter for the determination of the property of the material.

According to an example embodiment of the present invention, the location-dependent grain size-dependent parameter is determined preferably as a function of a parameter which characterizes a predefined material class of the material, the function being weighted using the parameter. This parameter is particularly well suited for determining the location-dependent grain size-dependent parameter for the determination of the property of the material.

The grain size-independent parameter characterizes preferably a kinematic hardening of the material, the location-dependent grain size-dependent parameter being determined as a function of the grain size-independent parameter that characterizes the critical shear stress of the material and as a function of the grain size-independent parameter that characterizes the kinematic hardening of the material, as a function of the parameter that characterizes the predefined material class of the material, as a function of a parameter that characterizes a predefined hardening class of the material, and/or as a function of the grain size-independent parameter that characterizes the kinematic hardening of the material. These parameters are particularly well suited for determining the property.

The property of the material characterizes preferably an influence of grain sizes for a substance, the substance being optimized in an optimization method as a function of the property, or the influence of a former austenite grain size on fatigue damage in a martensitic microstructure of the substance being determined as a function of the property of the material, or an initiation point of fatigue cracks in the substance being determined as a function of the property of the material, or the property of the material characterizing an influence of grain sizes for an electrical sheet, it being predicted as a function of the property of the material to what extent the grain size, in particular, in a web of the electrical sheet, affects a fatigue lifespan of the electrical sheet, and/or, as a function of the property of the material in an optimization process, a design of the electrical sheet being configured in such a way that magnetic and mechanical properties are optimally matched to one another. This represents exemplary applications.

In one example, it is determined that the property of the material fulfills a criterion and, as a function thereof, it is determined that the property of the material fulfills the criterion, a product including the material is manufactured or the material is approved for the manufacture of a product that includes the material. The determination of the property represents a simulation. Depending on the result of the simulation, the product is designed accordingly or is approved with the material that includes the simulated property. It may be provided that the product is otherwise not manufactured with the material or is not approved.

The criterion defines preferably a setpoint value for the property or for fatigue damage or for a fatigue lifespan of the material that includes the property or of a substance, which includes the material that includes the property.

According to an example embodiment of the present invention, a device for determining a property of a material includes at least one processor and at least one memory, the at least one processor being designed to execute instructions, upon execution of which by the processor a method according to the present invention proceeds, and the at least one memory being designed to store the instructions. This device yields advantages corresponding to those of the method.

According to an example embodiment of the present invention, a computer program, which includes computer-readable instructions, upon execution of which by a computer the method of the present invention proceeds, yields advantages corresponding to the advantages of the method.

### BRIEF DESCRIPTION OF THE DRAWINGS

Further advantageous specific embodiments of the present invention may be derived from the following description and from the figures.

FIG. 1 shows a device for determining a material behavior, according to an example embodiment of the present invention.

FIG. 2 shows a method for determining the material behavior, according to an example embodiment of the present invention.

### DETAILED DESCRIPTION OF EXAMPLE EMBODIMENTS

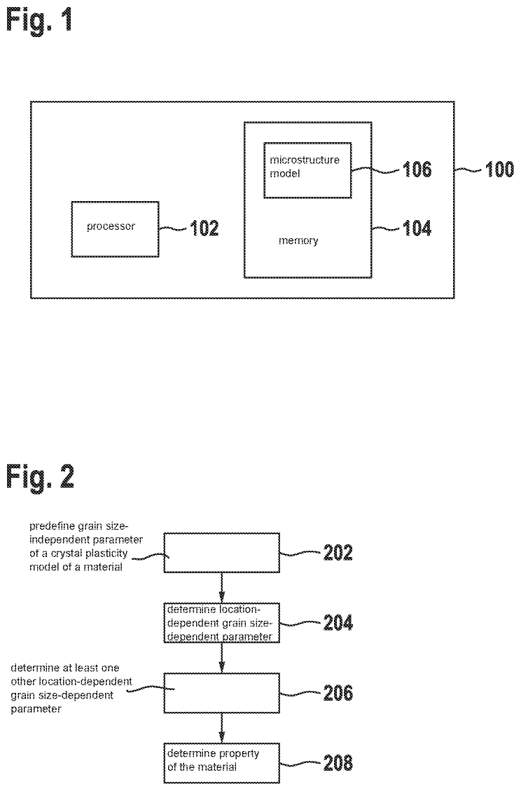

A device 100 is schematically represented in FIG. 1. Device 100 includes at least one processor 102 and at least one memory 104.

Device 100 is designed for determining a property of a material, in particular, using a microstructure model 106. Microstructure model 106 includes a crystal plasticity model.

Microstructure model 106 in the example includes at least one element.

Microstructure model 106 in the example includes a finite elements microstructure model, i.e., a microstructure model that includes a plurality of individual elements. For each of the elements in this case, the material behavior is evaluated individually at the integration points. Without limiting the generality, one integration point per element is assumed in the following.

A computer-implemented method for determining a property of the material using microstructure model 106, in particular, using the finite elements microstructure model, is described below for one element. The same procedure applies for other elements.

The at least one processor 102 is designed, in particular, to execute computer-readable instructions, upon execution of which by processor 102 the method proceeds. The at least one memory 104 in the example is designed to store microstructure model 106 and the instructions, in particular, a computer program that includes the instructions.

The method includes a step 202.

In step 202, at least one grain size-independent parameter of a crystal plasticity model of a material is predefined. In the example, the grain size-independent parameters σ_{y}*,A*,B* are predefined.

The grain size-independent parameter σ_{y}* characterizes a critical shear stress of the material.

The grain size-independent parameters A*,B* characterize a kinematic hardening of the material.

It may be provided that at least one grain size-independent parameter is determined regardless of the grain size using an inverse parameter identification.

For example, data are experimentally recorded, in particular, a reaction of the material to a pressure load, from which one of the grain size-independent parameters or the grain size-independent parameters are determinable using the inverse parameter identification. The data are measured, for example, on a real existing material. The one of the grain size-independent parameters or the grain size-independent parameters are determined as a function of the data using an inverse parameter identification.

The grain size-independent parameters σ_{y}*,A*,B* in the example are predefined location-independently.

The method includes a step 204.

In step 204, at least one location-dependent grain size-dependent parameter is determined. The location-dependent grain size-dependent parameter characterizes a physical state of the material. The grain size-dependent parameter σ_{y}(x) in the example characterizes a critical shear stress of the material, i.e., the material behavior at the integration point to which the element is assigned. The grain size-dependent parameters A(x),B(x) in the example characterize a kinematic hardening of the material, i.e., the material behavior at the integration point to which the element is assigned.

In the example, at least one grain size-dependent parameter for the element is determined as a function of the at least one grain size-independent parameter. In the example, the grain size-dependent parameters σ_{y}(x),A(x),B(x) for the element are determined as a function of the grain size-independent parameters σ*_{y},A*,B*.

In the example, the element is assigned to a location x in the material. In step 204, for example, a plurality of values of at least one of the location-dependent grain size-dependent parameters, which are assigned to one location x each in the material, is ascertained as a function of the at least one grain size-independent parameter. In the example, a plurality of values of the location-dependent grain size-dependent parameters σ_{y}(x),A(x),B(x), which are assigned to one location x each in the material, is determined as a function of the grain size-independent parameters σ*_{y},A*,B*.

For example, the element is assigned the at least one grain size-dependent parameter, which is assigned to the same location x as the element. In the example, the element is assigned the grain size-dependent parameters σ_{y}(x),A(x),B(x), which are assigned to the same location x as the element.

It may be provided that the at least one grain size-independent parameter is assigned to a part of a volume of the material. It may be provided that the plurality of location-dependent grain size-dependent parameters is assigned to the part of the volume of the material. In step 204, for example, values of the at least one parameter of the plurality of location-dependent grain size-dependent parameters are determined, whose mean value, i.e., whose volume-weighted mean value is essentially the same as the at least one grain size-independent parameter.

In the example, the grain size-independent parameters σ*_{y},A* are each assigned to a volume V of the material. The plurality of location-dependent grain size-dependent parameters σ_{y}(x),A(x) is assigned to a part of the volume V of the material. In step 204, at least one value, for which a respective volume-weighted mean value of the values of this location-dependent grain size-dependent parameter σ_{y}(x),A(x),B(x) that are assigned to the part of the volume V is essentially the same as the respective grain size-independent parameter σ*_{y},A*,B*, is determined for at least one of the grain size-dependent parameters σ_{y}(x),A(x),B(x).

It may be provided that the volume V is subdivided into a number n_{grain} of grains. In the example, the grains are considered to be subvolumes of the volume V. In one example, for a grain that is assigned to the same location x to which the element is also assigned, an equivalent diameter d(x) of the grain is ascertained as a function of a predefined distribution of equivalent diameters d for grains of the material in the volume V, and the location-dependent grain size-dependent parameter σ_{y}(x)=σ_{y0}+k/√d(x) is determined as a function of the equivalent diameter d(x) of this grain.

The distribution of equivalent diameters d for creating a microstructure for a simulation model is determined, for example as a function of microstructure data that characterize a grain size. The microstructure data may be predefined, or may be determined by an experimental grain size determination at the material.

It may be provided to proceed accordingly for the other grains and elements at other locations.

In one example, the location-dependent grain size-dependent parameter

$${σ}_{y} ( \underline{x} ) = {σ}_{y 0} + \frac{k}{\sqrt{d ( \underline{x} )}}$$

is determined for the grains of the material in the volume V as a function of the grain size-independent parameter σ*_{y} and of sums of functions, in particular, potencies, which are evaluated as a function of the equivalent diameters dᵢ

$${σ}_{y 0} = {σ}_{y}^{*} - k \frac{{\sum }_{i = 1}^{{n}_{grain}} {( {d}_{i} )}^{2.5}}{{\sum }_{i = 1}^{{n}_{grain}} {( {d}_{i} )}^{3}}$$

the parameter k characterizing a predefined material class of the material with which the aforementioned term is weighted, and σ_{y} representing a resulting critical shear stress and d an equivalent grain diameter at a location x, and a σ_{y0} and k being material constants, for example, from the literature. The grain size-independent parameter σ*_{y} is regarded as a volume mean value of the critical shear stress for a material considered, i.e. that in the example, the integral of the resulting critical shear stress standardized to the volume V over the volume V considered should be the same as the grain size-independent parameter σ*_{y}:

$$\frac{1}{V} {\int }_{V} {σ}_{y} ( \underline{x} ) dv = {σ}_{y}^{*}$$

A corresponding distribution of equivalent diameters is ascertained, for example, from electron backscatter diffraction data (EBSD). Thus, the determination of σ_{y0} takes place purely on the basis of measured data and of the constant k. The constant k for example, for the material considered, is taken from a literature source, for example, H. Lim, M. Lee, J. Kim, B. Adams, R. Wagoner, “Simulation of polycrystal deformation with grain and grain boundary effects,” International Journal of Plasticity 27 (9) (2011) 1328-1354. doi:10.1016/j.ijplas. 2011.03.001.

Kinematic hardening parameters are generally size-dependent and in one example are selected compatible to the value of a critical shear stress in order not to change the homogenized stress-strain behavior, on which a determination of the grain size-independent parameters σ*_{y},A*,B* is based. For this purpose, a dimensionless form of the shear rate equation, for example,

\dot{γ}^{α}=\dot{γ}₀sign(\tilde{τ}^{α}−\tilde{χ}^{α})|\tilde{τ}^{α}−\tilde{χ}^{α}|^{m}

γ^{α} being a shear distortion, τ^{α} being a shear stress, χ^{α} being a back stress of the material considered and the notation (·) representing a reference to σ_{y}:

(·)/σ_{y}

and for \dot{\tilde{χ}}^{a} according to the Ohno-Wang hardening behavior, it being the case that

$${\dot{\tilde{χ}}}^{α} = A {\dot{γ}}^{α} - {B ( \frac{\vert {\tilde{χ}}^{α} \vert}{A / B} )}^{M} {\tilde{χ}}^{α} {\dot{γ}}^{α}$$

the kinematic hardening parameters being taken into consideration by the parameters A and B while taking the Hall-Petch effect into account. The variables \dot{γ}₀,m,M are material parameters, which are taken, for example, from a literature source for the material, for example, B. Schäfer, X. Song, P. Sonnweber-Ribic, H. ul Hassan, A. Hartmaier, “Micromechanical Modelling of the Cyclic Deformation Behavior of Martensitic SAE 4150-A Comparison of Different Kinematic Hardening Models,” Metals 9 (3) (2019) 368. doi:10.3390/met9030368.

The following definitions of the parameters A and B do not change a homogenized stress-strain behavior:

A=A*σ_{y}*

B=B*

the parameters A* and B* being independent of the grain size. The parameters A and B are determined, for example, for a reference state with inverse parameter identification without grain size dependencies. These are subsequently modeled as a function of the grain size. Without limitation of generality, no grain size dependency of B is provided in the example.

The location-dependent grain size-dependent parameter A is determined in one example as a function of the grain size-independent parameter σ*_{y} and as a function of the grain size-independent parameter A* and as a function of the parameter k

$$A = {A}_{y 0} + \frac{{k}_{A}}{\sqrt{d ( \underline{x} )}}$$

where A_{y0}=A*σ_{y0}
and k_{A}=A*k,
a parameter k_{A} characterizing a predefined hardening class of the material and the root term \sqrt{d(x)} modeling the location dependency. \

The method includes an optional step 206.

In step 206, at least one other location-dependent grain size-dependent parameter, for example, B(x) of the plurality of location-dependent grain size-dependent parameters is determined as a function of a previously determined location-dependent grain size-dependent parameter, for example, σ_{y}(x) and/or A(x).

A step 208 is subsequently carried out.

In step 208, the property of the material is determined using microstructural model 106. In the example, a physical property of the material is determined. For example, a mechanical property is determined, in particular, a hardness, density, tensile strength, compressive strength, stability, elasticity, plasticity. For example, a magnetic or an electrical property of the material is determined.

One general application for the simulation of the material behavior using microstructure model 106 is a simulation of a substance, an influence of grain sizes for the substance being determined in the simulation.

An optimization of the substance may be provided, an influence of grain sizes for the substance being determined in the simulation and being optimized in the optimization.

The simulation of the influence of the grain sizes is used, for example, for analyzing the influence of the former austenite grain size on the fatigue damage and fatigue lifespan for martensitic microstructures.

The simulation of the influence of the grain size is used, for example, for determining an initiation point of fatigue cracks.

The simulation of the influence of various grain sizes is used, for example, for an electrical sheet, it being estimated to what extent the grain size, for example, in a web of the electrical sheet, affects a fatigue lifespan. This helps to configure a design of the electrical sheet in such a way that magnetic and mechanical properties are optimally matched to one another.

It may be provided that the property is determined in a simulation.

In the simulation, it is checked whether or not the property of the material fulfills a criterion.

In one example, the criterion defines a setpoint value for the property. In one example, the criterion defines a setpoint value, with which fatigue damage or a fatigue lifespan of the material is achieved with the property. In one example, the criterion defines a setpoint value, with which fatigue damage or a fatigue lifespan of a substance including the material that includes the property is achieved.

It may be provided that as a function of it being established that the property of the material fulfills the criterion, a product that includes the material is manufactured. It may be provided that otherwise the product is not manufactured with the material.

It may be provided that as a function of it being established that the property of the material fulfills the criterion, the material is approved for a manufacture of a product that includes the material. It may be provided that otherwise the product is not approved with the material.

1-13. (canceled)

14. A computer-implemented method for determining a micromechanical property of a material for describing grain size dependencies, the method comprising the following steps:
predefining a grain size-independent parameter;
determining a grain size-dependent parameter as a function of the grain size-independent parameter; and
determining the property of the material as a function of the grain size-independent parameter and of the grain size-dependent parameter.

15. The method as recited in claim 14, wherein the grain size-independent parameter is predefined as being location-independent, one location-dependent grain size-dependent parameter of a plurality of location-dependent grain size-dependent parameters being determined as a function of the grain size-independent parameter, at least one other location-dependent grain size-dependent parameter of the plurality of location-dependent grain size-dependent parameters being determined as a function of the location-dependent grain size-dependent parameter.

16. The method as recited in claim 14, wherein the grain size-independent parameter is assigned to a part of a volume of the material, a plurality of values of one of the location-dependent grain size-dependent parameters being assigned to different locations in the part of the volume of the material, and a value of the location-dependent grain size-dependent parameter being determined for which a mean value of the plurality of values is essentially the same as the grain size-independent parameter.

17. The method as recited in claim 16, wherein the volume is subdivided into a number of grains, which are assigned to one location each, for a grain that is assigned to the location, an equivalent diameter of the grain being predefined as a function of a predefined distribution of equivalent diameters for grains of the material in the volume, and the value of the location-dependent grain size-dependent parameter being determined as a function of the equivalent diameter of the grain.

18. The method as recited in claim 17, wherein the distribution of equivalent diameters is determined as a function of microstructure data that characterize a grain size.

19. The method as recited in claim 17, wherein the grain size-independent parameter characterizes a critical shear stress of the material, the location-dependent grain size-dependent parameter being determined as a function of the grain size-independent parameter and of a function as dependent on the equivalent diameter for the grains of the material in the volume.

20. The method as recited in claim 19, wherein the location-dependent grain size-dependent parameter is determined as a function of a parameter that characterizes a predefined material class of the material, the function being weighted using the parameter.

21. The method as recited in claim 19, wherein the grain size-independent parameter characterizes a kinematic hardening of the material, the location-dependent grain size-dependent parameter being determined as a function of the grain size-independent parameter that characterizes the critical shear stress of the material, and: i) as a function of the grain size-independent parameter that characterizes the kinematic hardening of the material, and/or ii) as a function of the parameter that characterizes the predefined material class of the material, and/or iii) as a function of a parameter that characterizes a predefined hardening class of the material, and/or as a function of the grain size-independent parameter that characterizes the kinematic hardening of the material.

22. The method as recited in claim 14, wherein: i) the property of the material characterizes an influence of grain sizes for a substance, the substance being optimized in an optimization method as a function of the property, or ii) the influence of a former austenite grain size on fatigue damage in a martensitic microstructure of the substance being determined as a function of the property of the material, or iii) an initiation point of fatigue cracks in the substance being determined as a function of the property of the material, or iv) the property of the material characterizing an influence of grain sizes for an electrical sheet, it being predicted as a function of the property of the material to what extent the grain size in a web of the electrical sheet, affects a fatigue lifespan of the electrical sheet, and/or a design of the electrical sheet being configured in an optimization method as a function of the property of the material in such a way that magnetic and mechanical properties are optimally matched to one another.

23. The method as recited in claim 14, wherein it is determined that the property of the material fulfills a criterion and, based on it being determined that the property of the material fulfills the criterion, a product that includes the material is manufactured or the material is approved for a manufacture of a product that includes the material.

24. The method as recited in claim 23, wherein the criterion defines a setpoint value: i) for the property, or ii) for fatigue damage, or iii) for a fatigue lifespan of the material that includes the property or of a substance including the material that includes the property.

25. A device configured to determine a micromechanical property of a material, the device comprising:
at least one processor; and
at least one non-transitory memory on which are stored instructions for determining the micromechanical property of the material for describing grain size dependencies, the instructions, when executed by the processor, causing the processor to perform the following steps:
predefining a grain size-independent parameter;
determining a grain size-dependent parameter as a function of the grain size-independent parameter; and
determining the property of the material as a function of the grain size-independent parameter and of the grain size-dependent parameter.

26. A non-transitory computer-readable medium on which is stored a computer program including computer-readable instructions for determining a micromechanical property of a material, for describing grain size dependencies, the instructions, when executed by a computer, causing the computer to perform the following steps:
predefining a grain size-independent parameter;
determining a grain size-dependent parameter as a function of the grain size-independent parameter; and
determining the property of the material as a function of the grain size-independent parameter and of the grain size-dependent parameter.
